(19) United States
(12) Patent Application Publication
(10) Pub. No.: US 2009/0259483 A1
(43) Pub. Date: Oct. 15, 2009

(54) Method for making a land management decision based on processed elevational data

(76) Inventors: Larry Lee Hendrickson, Johnston, IA (US); Rendel B. Clark, Mandeville, LA (US)

Correspondence Address: DEERE & COMPANY, ONE JOHN DEERE PLACE, MOLINE, IL, 61265, US

(21) Appl. No.: 12/148,021

(22) Filed: Apr. 16, 2008

Related U.S. Application Data
(60) Provisional application No. 61/044,158, filed on Apr. 11, 2008.

(51) Int. Cl. G06Q 99/00

(52) U.S. Cl. 705/1

(57) ABSTRACT

A method for making a land management decision comprises surveying a field with a location-determining receiver to determine position data and corresponding elevation data. A data processor or elevation module determines an average elevation data for a zone within the field around a particular cell. The data processor or classifier classifies each cell into classifications comprising a depression cell and a summit cell based on the determined elevation difference between the particular cell and the average elevation. The data processor and the prescription module generate a prescription for the cells in the field based on at least one of the classification and the determined elevation difference.

This document (including the drawings) claims the benefit of the filing date of U.S. Provisional Application No. 61/044,158, filed Apr. 11, 2008, under 35 U.S.C. 119(e).

### FIELD OF THE INVENTION

This invention relates to a method for making a land management decision (e.g., agricultural decision) based on processed elevation data.

### BACKGROUND OF THE INVENTION

Farmers, crop consultants and others have used conventional soil surveys to manage the application of various crop inputs. In one example, soil may be collected on a grid basis and analyzed in a laboratory to determine nutrient levels, water holding capacity, clay content, and organic matter content, or other soil characteristics of interest. In another example, in situ soil sampling techniques may rely upon mobile testing, which might involve in-field optical or spectroscopic analysis of the collected samples. However, such soil sampling techniques require the expense of in-field analysis or potential delay of laboratory soil analysis. Accordingly, there is a need for using elevation data or other information that may be readily available with minimal expense and without laboratory analysis.

### SUMMARY OF THE INVENTION

A method for making a land management decision comprises surveying a field with a location-determining receiver to determine position data and corresponding elevation data. A data processor or elevation module determines an average elevation data for a zone within the field around a particular cell. The data processor or classifier classifies each cell into classifications comprising a depression cell and a summit cell based on the determined elevation difference between the particular cell and the average elevation. The data processor and the prescription module generate a prescription for the cells in the field based on at least one of the classification and the determined elevation difference.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram of a system for making a land management decision based on processed elevation data.

FIG. 2 is a flow chart of one embodiment of a method for making a land management decision based on processed elevation data.

FIG. 3 is a flow chart of another embodiment of a method for making a land management decision based on processed elevation data.

FIG. 4A shows elevation contours within a work area or field.

FIG. 4B shows landscape position contours or zones within the work area or field of FIG. 4A.

FIG. 4C shows the landscape position zones of FIG. 4B, which are further defined to cover approximately equal spatial areas.

FIG. 5A is an illustrative yield map for a crop within a somewhat round field.

FIG. 5B is the yield map of FIG. 5A superimposed on an elevation map applicable to the same region as the yield map of FIG. 5A.

FIG. 6 is a graph of crop yield (e.g., in bushels per acre) versus landscape position zones or classifications.

FIG. 7 is an illustrative prescription or land management decision consistent with the yield map of FIG. 5A.

FIG. 8 is another illustrative prescription, which is related to land surface sculpting, consistent with the yield map of FIG. 5A.

FIG. 9 is a block diagram of another embodiment of the system for making a land management decision based on processed elevation data.

FIG. 10 is a flow chart of yet another embodiment of a method for making a land management decision based on processed elevation data.

FIG. 11 is a flow chart of still another embodiment of a method for making a land management decision based on processed elevation data.

### DESCRIPTION OF THE PREFERRED EMBODIMENT

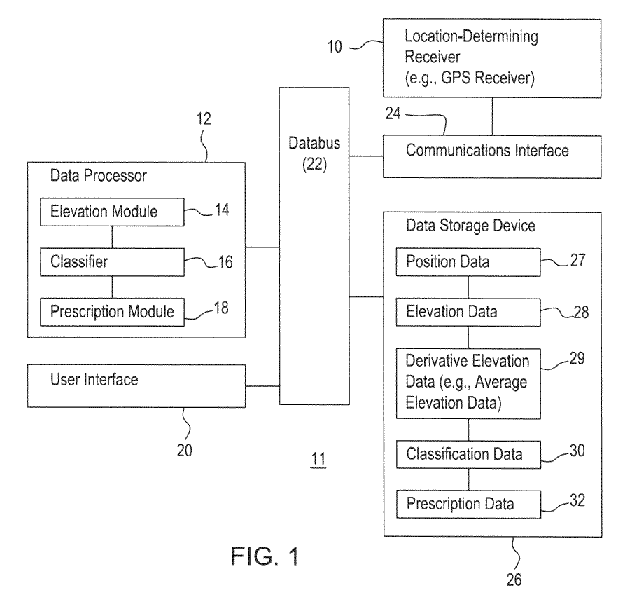

In accordance with one embodiment of the invention, FIG. 1 illustrates a system 11 for making land management decisions (e.g., agricultural or agronomic decisions, water drainage decisions, or construction decisions) based on processed elevation data. A land management decision refers to any decision, design or plan that relates to management of a plot or area of land, including, but not limited to, agricultural decisions, crop treatment plans, application of agricultural inputs (e.g., pesticides, herbicides, fungicides, nutrients, water or fertilizer), construction plans (e.g., for roads, buildings, bridges, or other structures), and land sculpting plans, land shaping plans, land leveling plans and environmental remediation plans (e.g., construction of parks or golf courses).

The system 11 of FIG. 1 comprises a location-determining receiver 10 coupled to a communications interface 24. In turn, the communications interface 24 is coupled to a data bus 22. A data processor 12 may communicate with the location-determining receiver 10 via the communications interface 24. Further, the data processor 12 may communicate with one or more of the following components via the data bus 22: a user interface 20, a communications interface 24, and a data storage device 26.

The data processor 12 generally comprises a microprocessor, a digital signal processor, a logic circuit, a programmable logic array, or another data processing device. The data processor 12 comprises an elevation module 14, a classifier 16 and a prescription module 18. The elevation module 14, classifier 16 and prescription module 18 may represent program instructions or software modules, for example.

The data storage device 26 facilitates storing and retrieving of data, including one or more of the following: position data 27, elevation data 28, classification data 30, and prescription data 32. The position data 27 may be expressed in coordinates (e.g., x, y coordinates). The elevation data 28 may be expressed as a height above sea level or another reference elevation. The elevation data 28 (e.g., expressed as a z coordinate) may be associated with a corresponding position data 27 (e.g., expressed as x, y coordinates). The classification data 30 represents a classification or categorization of elevation data, or a derivative of elevation data. Prescription data 32 may comprise a location-dependent plan of land management or crop inputs.

The prescription data 32 may vary with classifications, for example. The classifications may comprise a summit cell, an intermediate cell and a depression cell. Each particular cell is classified with respect to a local area, region, zone or cluster of cells about the particular cell. A summit cell represents a locally high or higher elevation of a particular cell than a local average elevation determined based on a local area, region, zone or cluster of cells. A depression cell represents a locally low or lower elevation of particular cell than a local average elevation determined based on a local area, region, zone or cluster of cells. An intermediate cell has an intermediate elevation based on a local area, region, zone or cluster of cells.

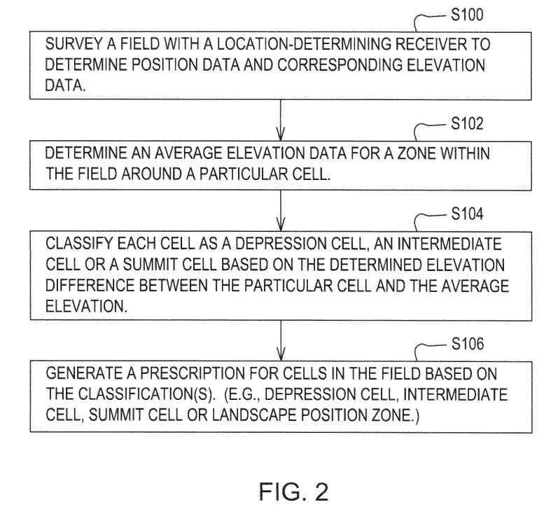

FIG. 2 describes a flow chart of a method for determining a land management decision based on processed elevation data. The method of FIG. 2 begins in step S100.

In step S100, a location-determining receiver 10 may be used to survey a field to determine position data 27 and corresponding elevation data 28. For example, the location-determining receiver 10 may obtain position data (e.g., x, y coordinates of a Cartesian coordinate system 11) and elevation data 28 (z coordinate of a Cartesian coordinate system 11) during normal field operations (e.g., during planting, harvesting or spraying), or from a dedicated survey (e.g., transects or grid sampling movements made with a vehicle to collect respective position data 27 and elevation data 28).

In one example, the data processor 12 or elevation module 14 expresses the position data and corresponding elevation data 28 as a three-dimensional elevation surface, a two-dimensional color image or a first data layer. The three-dimensional elevation surface or first data layer may be expressed as a matrix (e.g. single or multidimensional), or database or table with related entries or records of elevation data and corresponding position data.

In a color image, each pixel is expressed as color data in color space. If the elevation data 28 is expressed as color data in color space (e.g., RGB (red, green, blue) color space or HSV (hue, saturation, value) color space), the processing of the processor or elevation module 14 may take place on the underlying numerical values of elevation (e.g., expressed in feet or meters) or on the pixel values or voxel values in color space that represent elevation data 28. For example, if the colorization of the data is merely used to provide a visualization of the elevation data or first data layer on a display of the user interface 20, the processing may take place on the underlying numerical values of elevation, as opposed to the pixel values or voxel values.

In an alternate embodiment, step S100 may be omitted, where position data 27 and elevation data 28 is available from commercially available or governmental sources (e.g., databases). Ground elevation data may be based on surveys or LIDAR (light detection and ranging) to determine the surface topography of a field or region.

In step S102, an elevation module 14 or data processor 12 determines average elevation data 28 or derivative elevation data 29 for a defined zone within the field around a particular cell. The cell may be generally rectangular, polygonal or have another geometric shape with a generally uniform surface area. The defined zone may comprise a region within a defined radius, polygon, area or group of adjacent cells.

In one example of step S102, the elevation module 14 or data processor 12 creates an average elevation surface or second data layer based on one or more of the following: (1) the determined position data 27 and corresponding elevation data 28, or (2) processed or interpolated elevation data associated with corresponding position data. Interpolated or processed elevation data means elevation points that represent an average, mean, median, or mode value or other estimated value of elevation data 28 based on the elevation data 28 associated with the nearest position data or adjacent position data. The determination of the average elevation data 28 or derivative elevation data 29 in step S102 may facilitate greater accuracy from removing or reducing the impact of outlying data points of elevation data 28.

In one example, the data processor 12 or elevation module 14 expresses the position data and corresponding average elevation data 28 as a three-dimensional average elevation surface, a mean filter surface, a color image or a second data layer. In the color image representation of the second data layer, each pixel is expressed as color data in color space. If the elevation data 28 is expressed as color data in color space (e.g., RGB (red, green, blue) color space or HSV (hue, saturation, value) color space), the processing of the processor or elevation module 14 may take place on the underlying numerical values of elevation (e.g., expressed in feet or meters) or, alternatively, on the pixel values or voxel values in color space that represent elevation data 28. The second data layer may be expressed as a matrix, database, or table with related entries or records of average elevation data or a derivative elevation data 29 and corresponding position data 27.

In step S104, the classifier 16 or data processor 12 classifies each cell as a depression cell, an intermediate cell or a summit cell based on the determined elevation difference between the particular cell and the average elevation or derivative elevation data 29. In one example, the mean filter surface (e.g., the second data layer) is subtracted from the elevation surface (e.g., first data layer) to create a landscape position (LSP) surface or third data layer. The three dimensional surface may be graphically modeled such that the position on the surface represents the position coordinates (e.g., x, y coordinates) of the field or land, whereas the corresponding color of the surface represents the elevation (e.g., z coordinate) of the land at the corresponding position. The LSP surface or third data layer can show the distance or height of each new cell above or below the regional inflection point (e.g., mean height or local mean height). The third data layer may be expressed as color data in color space or as a matrix, database or table with related entries or records of average elevation data or a derivative elevation data 29 and corresponding position data 27.

The LSP surface or third data layer can be used directly or instead can be linked to a derived slope layer that is divided into zones or classifications, such as depression cell, summit cell, intermediate cell, or other zone identifiers. In one example, if cell classifications are used, the summit cells and intermediate cells are associated with less available moisture in top soil than depression cells. In another example, summit cells and intermediate cells are associated with lesser water holding capacity than the depression cells. Each zone identifier may represent a distinct range of determined elevation differences between the particular cells and the respective average elevations.

In step S106, a user interface 20 generates a prescription for cells in the field based on at least one of the classification, the landscape position (LSP) surface or the third data layer. The prescription may comprise one or more of the following: (1) instructions, plans or information (e.g., a data file) on applying or allocating different levels of an agricultural input to particular cells in the field based on the different classifications of the particular cells or other landscape position surface values; (2) instructions, plans, or information (e.g., data file) on removing soil or material from summit cells to fill in depression cells to meet an average elevation for the cells, (3) instructions, plans or information (e.g., a data file) on changing an elevation of one or more cells to achieve a target elevation, and (4) instructions, please or information on adding soil or material to depression cells. Agricultural inputs may include pesticides, fungicides, herbicides, mildewicides, fertilizer, nutrients, seeding rate, seeding density, or other chemicals or materials for agronomic or plant management. The prescription may be expressed in visual graphical form or as prescription signals or prescription data 32 that can be used to control a vehicle, equipment, machine, or its implement to further or execute the prescription.

The prescription data may be stored as a data file that is specific or peculiar to a particular field or work area. For example, the data file may contain one or more of the following: (1) cell classifications associated with corresponding agricultural input amounts, (2) elevation differences of cells associated with corresponding agricultural input amounts, (3) position data or position data ranges associated with corresponding cell classifications, (4) position data associated with corresponding agricultural input amounts, (5) elevation differences of cells associated with corresponding agricultural input amounts, and (6) landscape position data associated with corresponding agricultural input amounts.

In the agricultural context, step S106 may comprise applying different levels of an agricultural input to particular cells based on at least one of the classification of particular ones of the cells or the determined elevation differences for particular ones of the cells. Step S106 may be carried out in accordance with various techniques that may be applied alternately and cumulatively.

In according with a first technique, a data processor 12 or prescription module 18 generates a prescription where a first input amount of the agricultural input differs from a second agricultural input amount for the depression cell.

In accordance with a second technique, a data processor 12 or prescription module 18 generates the prescription to allocate or apply a greater amount, volume or rate (e.g., gallons or liters per minute) of water (e.g., irrigation water or another similar agricultural input) to the summit cells than the depression cells to maximize yield, crop performance or reduce variability in the crop yield. In one variation of the second technique, the prescription may allocate or apply a greater amount, volume or rate of water to intermediate cells (e.g., slope cells) than the depression cells to maximize yield, crop performance or reduce variability in the crop yield. Alternatively, the prescription may allocate an intermediate amount, rate or volume of water to intermediate cells that is intermediate between the amount, rate or volume allocated to summit cells and depression cells.

In accordance with a third technique, the data processor 12 or prescription module 18 generates a prescription to allocate or to apply greater amount, volume or rate of nitrogen fertilizer (e.g., or a similar agricultural input) to the summit cells and a lesser amount, volume or rate of nitrogen fertilizer to the depression cells to maximize yield, crop performance or reduce variability in the crop yield. In one variation of the third technique, the prescription may allocate or apply a greater amount, volume or rate of nitrogen fertilizer to intermediate cells than the depression cells to maximize yield, crop performance or reduce variability in the crop yield. Alternatively, the prescription may allocate an intermediate amount, rate or volume of nitrogen fertilizer to intermediate cells that is intermediate between the amount, rate or volume allocated to summit cells and depression cells.

In accordance with a fourth technique, the data processor 12 or prescription module 18 generates a prescription that comprises a first nutrient amount (e.g., at a first nutrient application rate) and a first water quantity (e.g., at a first water application rate) for the summit cell that exceeds a second nutrient amount and second water quantity for the depression cell.

In accordance with a fifth technique, the data processor 12 or prescription module 18 generates a prescription that comprises a plan (e.g., data file) for varying seeding rates of seed (e.g., tubers, root stock, bulb, seedling, sapling or a similar agricultural input) based the classification as a depression cell, an intermediate cell or a summit cell. For example, the seeding rate or seeding density (e.g., seeds per linear meter of a row or group of rows) of intermediate cells may be increased if the intermediate cells can support a greater density of growing plants and greater yield.

In accordance with a sixth technique, the data processor 12 or prescription module 18 generates a prescription or plan (e.g., data file) that comprises increasing the tillage depth in depression cells and reducing or using a low tillage procedure in the summit cells. In a variation of the sixth technique, the data processor 12 or prescription module 18 generates a prescription or plan that comprises reducing or using a low tillage procedure for intermediate cells.

In accordance with a seventh technique, the data processor 12 or prescription module 18 generates a prescription that comprises using seeds that have particular genetic characteristics or genotypes (e.g., variety, hybrid or genetically modified traits) that are well suited for or matched to the corresponding cell classification or elevation data to promote a superior yield or performance of the crop arising from the seed. For example, the data processor 12 or prescription module 18 generates a prescription that comprises using drought-resistant seeds or genetically tailored seeds in the summit cells and the intermediate cells (e.g., slope cells). In accordance with an eighth technique, the data processor 12 or prescription module 18 generates a prescription that comprises using seeds (e.g., bulbs, root stock, tubers, or similar agricultural inputs) treated with mildewicide or water-resistant seed varieties in the depression cells.

In accordance with a ninth technique, the data processor 12 or prescription module 18 links landscape position (LSP) parameters to prescription generation software to create variable nutrient rate prescriptions for a variety of inputs or practices. For example, growers may apply higher rates of nitrogen (N) in eroded zones to make up for the differential supply of soil N in some fields. Alternatively, growers may apply lower rates of N to these eroded zones in environments with lower soil N supplies and where water more frequently limits crop yields. The ninth technique may require augmentation of LSP data or augmenting LSP data with one or more of the following: rainfall data, weather data, irrigation data, soil sampling tests (e.g., grid sampling), soil analysis, top soil depth, soil survey results, and soil classifications.

In accordance with a tenth technique, the data processor 12 or prescription module 18 may vary their seeding rates to avoid high seed costs in low yield potential zones with in the LSP zones.

In accordance with an eleventh technique, the data processor 12 prescription module 18 may also modify their tillage based upon landscape position data (LSP), reducing tillage in more erosion prone zones or increasing depth of tillage in low landscape positions due to greater compaction problems in these wetter soils. The eleventh technique may require augmentation of LSP data with soil sampling tests, soil survey results, soil composition, soil moisture content, water-holding capacity, or any soil information relevant to soil erosion.

In the land-leveling, construction, and land-sculpting context, step S106 involves generating a prescription for the cells in the field based on at least one of the classification and the determined elevation difference, where the prescription comprises information or a plan on changing an elevation of one or more cells to achieve target elevation data. For example, the target elevation data may refer to a map of the cells where each cell has a localized target average elevation. Step S106 may be executed in accordance with various procedures that may be applied alternately or cumulatively.

In accordance with a first procedure, the data processor 12 or prescription module 18 generates a plan or information (e.g., a data file) for removing soil or material from summit cells to fill in depression cells to meet the target elevation data for a group of cells in the field. It should be recognized that it may be impractical or too expensive to meet the target elevation for all cells in the field, but that grading or reducing the overall variation in regions of the field may improve drainage, agricultural performance (e.g., crop yield), or meet other construction objectives.

In accordance with a second procedure, the data processor 12 or prescription module 18 generates a desired height for each evaluated cell based on a difference between an actual cell height and a corresponding average cell height. The corresponding average cell height may be based on the elevation of adjacent cells around, near or proximate to the evaluated cell.

In accordance with a first procedure, the data processor 12 or prescription module 18 generates a plan or information (e.g., a data file) for adding soil or material to depression cells to meet the target elevation data for a group of cells.

In one embodiment, the above prescriptions, techniques and procedures (e.g., for agricultural, construction, land shaping and land-sculpting) may be organized into a rule database or expert system database of if-then statements, data rules, or other conditional statements that are stored in the data storage device 26. The user interface 20 supports a user's entry of additional information that may be relevant to answering or resolving conditional aspects or the “if” portion of if-then statements or of data rules within the rule database. The data processor 12 may be programmed to limit the appropriate response or availability of possible prescriptions that are suitable for a particular field or work area based on the entered data and the evaluated aspects of the field (e.g., cell classifications or elevation differences), consistent with other aspects of the method of FIG. 2.

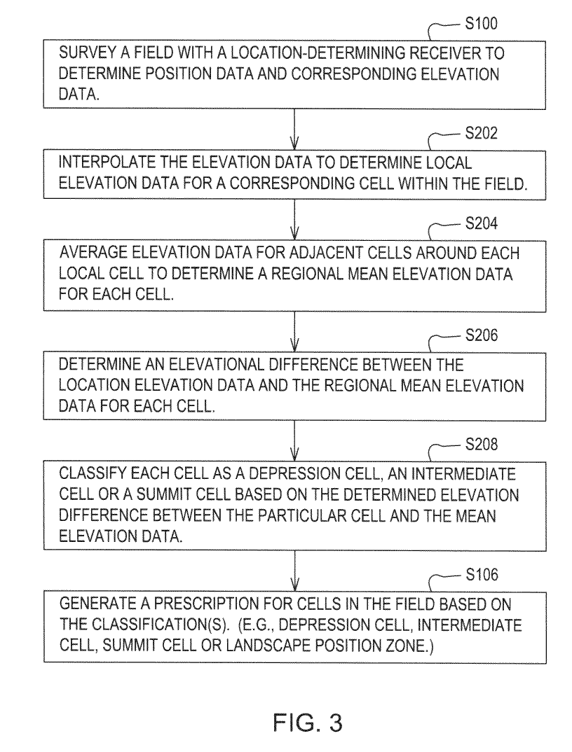

The method of FIG. 3 describes a flow chart of another method for determining a land management decision based on processed elevation data. Like reference numbers in FIG. 2 and FIG. 3 refer to like steps or procedures. The method of FIG. 3 begins in step S100.

In step S100, a location-determining receiver 10 may be used to survey a field to determine position data and corresponding elevation data 28. For example, the location-determining receiver 10 may obtain position data (e.g., x, y coordinates of a Cartesian coordinate system 11) and elevation data 28 (z coordinate of a Cartesian coordinate system 11) during normal field operations (e.g., during planting, harvesting or spraying), or from a dedicated survey (e.g., transects or grid sampling movements made with a vehicle to collect position and elevation data 28).

In an alternate embodiment, step S100 may be omitted, where position data and elevation data 28 is available from commercially available or governmental sources (e.g., databases) based on surveys or LIDAR (light detection and ranging) to determine the surface topography of a field or region.

In step S202, an elevation module 14 or data processor 12 interpolates the elevation data 28 to determine local elevation data 28 for a corresponding cell within the field. The cell may generally rectangular, polygonal or have another geometric shape of a generally uniform surface area. For example, the elevation module 14 or data processor 12 creates an elevation surface or first data layer based on one or more of the following: (1) the determined position data 27 and corresponding elevation data 28, or (2) interpolated elevation data with associated corresponding position data. Interpolated elevation data means elevation points that represent an average, mean, or mode value or other estimated value of elevation data 28 based on the elevation data 28 associated with the nearest position data or adjacent position data. If the elevation data 28 is expressed as color data in color space (e.g., RGB (red, green, blue) color space or HSV (hue, saturation, value) color space), the processing of the processor 12 or elevation module 14 may take place on the underlying numerical values of elevation (e.g., expressed in feet or meters) or the virtual representation of pixel values or voxel values in color space.

In step S204, an elevation module 14 or data processor 12 averages adjacent cells around each local cell to determine a regional mean elevation data or derivative elevation data 29 or derivative elevation data 29 for each cell. For example, the elevation module 14 or data processor 12 averages adjacent elevation data 28 around each cell (e.g., by a predetermined radius, maximum distance or a defined zone or two-dimensional area) to determine a mean elevation surface for each cell. The aggregate of the mean elevation surfaces for all cells within a region or field may be referred to as a mean filter surface or second data layer.

In step S206, an elevation module 14 or data processor 12 determines an elevation difference between the location elevation data 28 and the regional mean elevation data 28 (or derivative elevation data 29) for each cell. For instance, in step S206 the mean filter surface (e.g., second data layer) is subtracted from the elevation surface (e.g., first data layer) to derive or estimate a landscape position (LSP) surface (e.g., third data layer).

Step S206 may be carried out in accordance with various techniques that may be applied individually or cumulatively. In accordance with a first embodiment, the mean filter surface and elevation surface are expressed as multidimensional matrices or database records with values of elevation data 28 (e.g., z coordinate value) and position data (e.g., x, y coordinate values). Further, the subtraction may take place in accordance standard mathematical techniques. In accordance with a second embodiment, the elevation data 28 is expressed as color data in color space (e.g., RGB (red, green, blue) color space or HSV (hue, saturation, value) color space), the subtraction may take place on the pixel values or voxel values in color space that represent underlying elevation data 28.

In step S208, a classifier 16 or data processor 12 classifies each cell as a depression cell, an intermediate cell, a summit cell or another classification (e.g., distinct zone identifiers associated with different landscape position zones) based on the determined elevation difference between the particular cell and the mean data. Step S208 may be carried out in accordance with various techniques that may be applied alternately or cumulatively. In accordance with a first technique, each distinct zone may contain cells with the same or similar classifications. In accordance with a second technique, each distinct zone is associated with similar ranges of elevation differences with respect to the regional mean elevation. For example, a first zone identifier may describe a first range of elevation differences, whereas a second zone identifier describes a second range of elevation differences distinct (e.g., greater or lower) from the first range. In accordance with a third technique, the LSP surface may be classified (e.g., divided into N zones (1 to N) using various methods such as an equal surface area for each zone). In accordance with a fourth technique, the boundaries (e.g., contour or perimeter coordinates) of each zone may be applied to collected reference data, yield data, or image data to facilitate determination of a mean, average, mode of the reference data, yield data, or image data per corresponding zone in step S902 or prior thereto.

In step S106, a prescription module 18 or data processor 12 generates a prescription for cells in the field based on the classification or landscape position (LSP) zone. Other details of step S106 are set forth in conjunction with the description of FIG. 2 and such details of step S106 apply equally to FIG. 3 as if fully set forth herein.

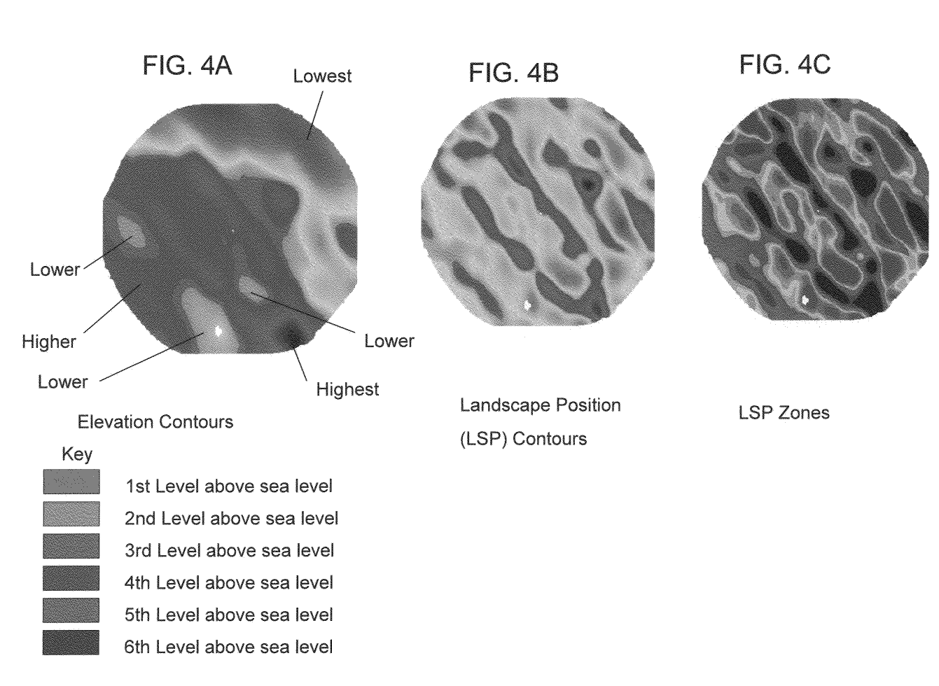

FIG. 4A shows illustrative elevation contours and zones for a generally circular area or field of land. Each zone may be defined by a contour or curved line that bounds it. Each zone is color-coded in accordance with the key set forth in FIG. 4A such that different colors and shades indicate different elevation levels. FIG. 4A provides an illustrative representation of the first data layer or elevation image.

Here, in FIG. 4A the first level above sea level is the lowest zone and is indicated in red. The second level above sea level is higher than the lowest zone and is indicated in orange. The third level of above sea level is higher than the second level and is indicated in a lighter shade of green. The fourth level above sea level is higher than the third level and is also represented by a darker shade of green. The fifth level is higher than the fourth level and is indicated by light blue. The sixth level is highest of all and is indicated by dark blue. The same color key for contours or zones applies to FIG. 4A, FIG. 4B and FIG. 4C.

FIG. 4B shows illustrative landscape position contours or third data layer that are derived from the land elevation contours of FIG. 4A. The landscape position contours represent the difference between an elevation of each cell and average elevation associated with surrounding or adjacent cells, for example. The average elevation for each cell may be expressed as a second data layer, as previously noted. Accordingly, the image of FIG. 4B may be a result of the subtraction of the second data layer from the first data layer of FIG. 4A.

In one embodiment, the landscape position layer has values of elevation or height above and below the zero height value for each corresponding position in a field or evaluated region. Each height value or elevation data may be colorized with pixel values for visualization at a display of the user interface 20. FIG. 4B is representative of the type of image of landscape position contours that could be displayed to a user via the user interface 20.

The landscape positions are generally more important to growing crops than raw elevation data (e.g., elevation data of FIG. 4A). For example, summit areas (e.g., summit cells) and sloped areas (e.g., intermediate cells) often have much less topsoil than lower areas (e.g., depression areas) on the landscape as a result of erosion occurring during soil formation. The reduced depth of topsoil on summit areas (e.g., summit cells) may result in less water holding capacity and are much more drought prone. Such eroded zones also have much less organic matter, and much less capability to provide nitrogen from soil reserves. Conversely, toe slope areas (e.g., intermediate cells) often have much greater depths of topsoil, much higher organic matter and available soil nitrogen supplies, and yields are often much higher in drought situations. However, such toe slope areas (e.g., intermediate cells) and depression areas (e.g., depression cells) are also much more prone to waterlogging, and yields are sometimes much lower in such lower landscape positions during wet seasons or periods.

The LSP zones may also enable more informed decisions about appropriate variety selections, either at the field level or even within fields, where decisions can be based upon propensity for insect (or nematode), disease, moisture stress, or nutrient problems (such as iron chlorosis).

The LSP zones can also be used in conjunction with other available layers, such as conductivity methods. For example, use of conductivity to estimate topsoil depth in areas impacted by salinity currently requires use of soil samples to make informed decisions. If one instead uses both layers, then consultants should be able to attribute salinity to any areas where the LSP and conductivity measurements are not aligned.

FIG. 4C shows illustrative landscape position zones, where the landscape position contours are arranged such that each range of landscape position zones represents a certain percentage of the total area within the circular area of land. For example, landscape position zones may be assigned such that each of 6 zones represents approximately 16.67 percent of the total land area. The landscape position contours of FIG. 4B or LSP zones of FIG. 4C may both be applied to the generation of land management decisions or prescriptions for the land.

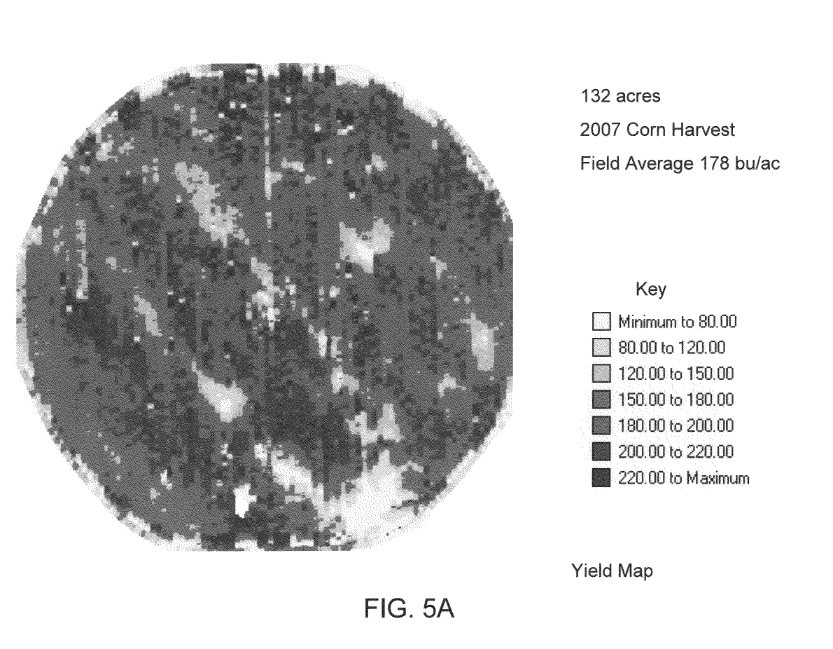

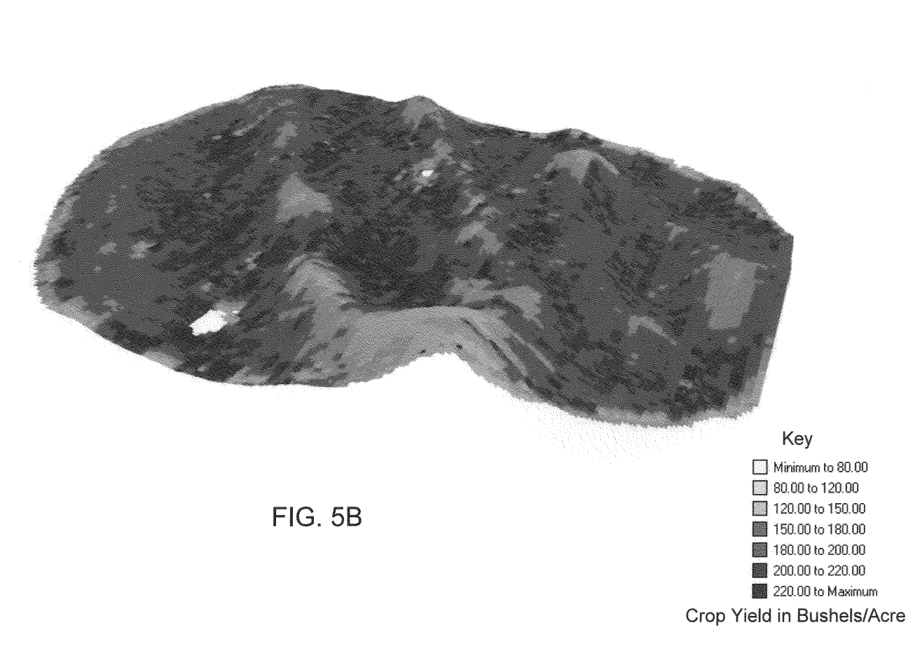

FIG. 5A shows an illustrative yield map for the same land area as FIG. 4A. Each different color or shade represents a distinct yield rate. A yield zone with a corresponding yield range is be indicated by a distinct color or shade. The perimeter or boundary of each yield zone may define a yield contour. The average yield for the exemplary field is approximately 178 bushels per acre and is merely disclosed for illustrative purposes.

FIG. 5B shows the yield map of FIG. 5A superimposed on a relief elevation map. The relief elevation map is an alternative display of the information earlier expressed as color zones or contours FIG. 4B. FIG. FIG. 5B shows a yield map draped over a three-dimensional representation of the LSP layer, where higher elevation areas or higher cells tend to have lower yields. FIG. 5B demonstrates that at least in some fields, that crop yields are significantly lower on ridge areas or summit areas (e.g., summit cells) than other parts of the field, presumably due to lower water infiltration. In some areas, lower topsoil depth or less desirable soil may be associated with summit areas (e.g. summit cells) more than depression areas (e.g., depression cells). However, differences in topsoil depth may not occur in less rolling areas or in leveled fields, where dryness of the summit areas (e.g., summit cells) may be independent of topsoil depth, for instance.

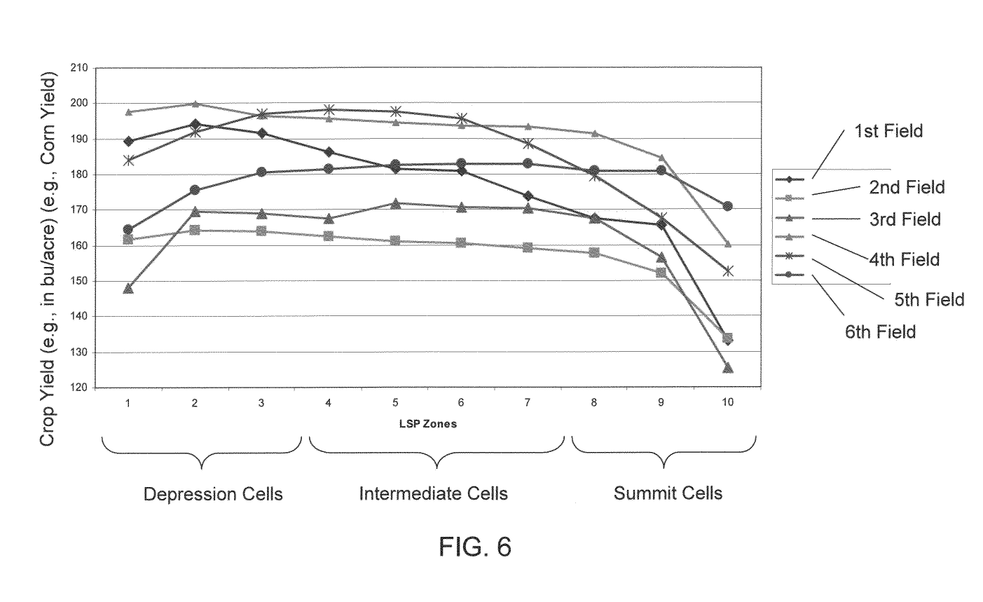

FIG. 6 shows an illustrative graph of crop yield versus landscape position (LSP) zones or landscape position contours. The vertical axis represents crop yield per land unit (e.g., bushels per unit acre). Although the crop yield may represent corn, it may represent the yield of any other crop.

The horizontal axis represents landscape position zones, which may be classified into depression cells, intermediate cells or summit cells that outputs the average yield for each of the LSP zones. Here, landscape position zones 1 through 3 refer to depression cells; landscape position zones 4-7 refer to intermediate cells, and landscape position zones 8-10 refer to summit cells. The fields tend to have significantly lower yields on the ridges or summit cells (e.g., zones 8-10). Some fields also tend to have reduced yields in depression areas or depression cells (e.g., zone 1-3).

Each line or curve in the graph represents a different field within a region. Here, the different fields include a first field, a second field, a third field, a fourth field, a fifth field and a sixth field. The fields may comprise portions of the generally circular region or an aggregate field, and each field may be separated from adjacent fields by established boundaries.

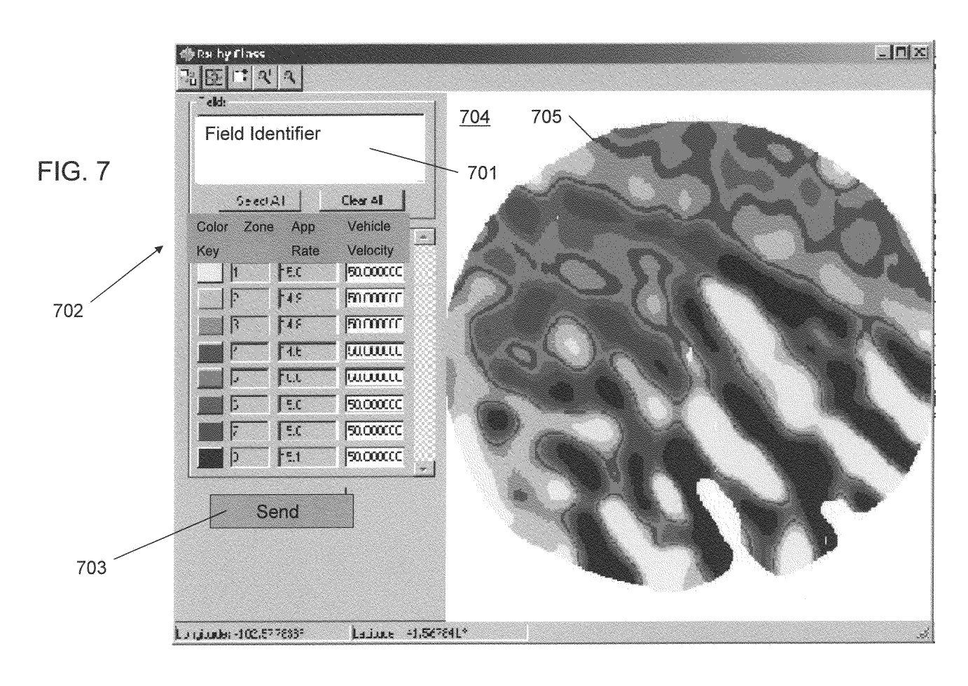

FIG. 7 shows a display or screen shot of a user interface 20 that accepts an entry or selection of field selection in box 701 for a field that has previously been surveyed or for which elevation data 28 is available. The system 11 provides a prescription map 705 for the land area in window or area 704. The prescription map 705 may include application rates per classification (e.g., landscape position zone on a color coded basis). A grower may assign a custom crop input level or rate for each LSP zone in an input table 702 or another input interface, for example. The system 11 also provides transfer or communication of the prescription to machinery in the field (e.g., by a user activating the send button 703). The prescription map 705 varies with the land and the objectives of the land management.

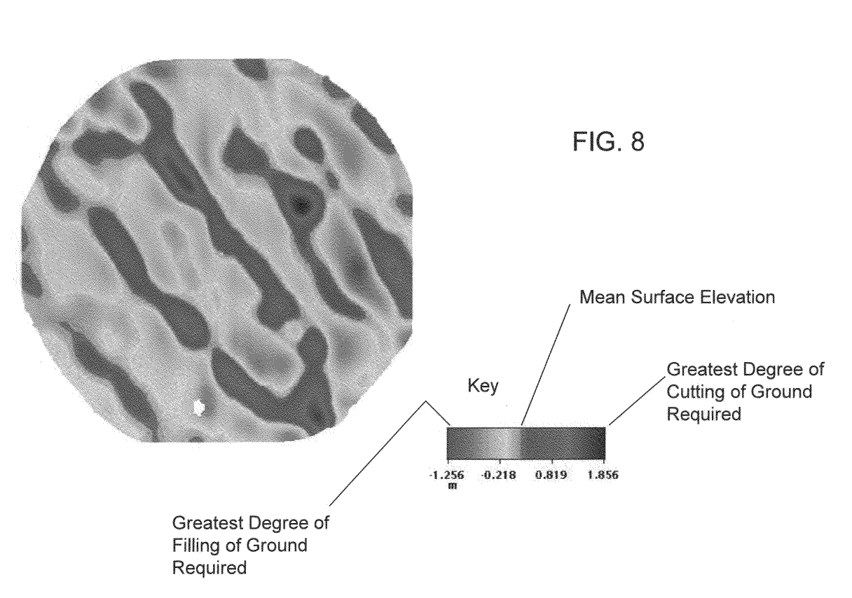

FIG. 8 shows a display or screen shot of a land management prescription that may be displayed on a user interface 20. The land management prescription illustrates primary zones that need to be cut (or reduced in elevation) and secondary zones that need to be filled to achieve better performance (e.g., crop yield) of the land associated with water drainage and availability of water or moisture to crops. There are primary subzones within the primary zones that need to be cut or reduced in elevation by specific or discrete amounts or ranges, as indicated by different colors or shades. There are secondary subzones within the secondary zones that need to be filled or raised in elevation by specific or discrete amounts or ranges, as indicated by different colors or shades.

The illustrative prescription of FIG. 8 describes the vertical height (e.g., in meters) from a mean vertical height or mean elevation. The illustrative contour areas in FIG. 8 separate the landscape into hills or summit cells (e.g., all areas with positive values) and valleys or depression cells (e.g., negative values). The greater the value, the higher the hill or deeper the valley is. If this prescription data 32 of FIG. 8 were used for land smoothing or land leveling, all pixels with positive values would be cut down to the zero surface, while all negative pixels would be filled to the zero surface. The foregoing zero surface is the mean filter surface as described in the method of FIG. 2 or any other method described herein, for instance.

In one embodiment, the illustrative prescription of FIG. 8 or a similar prescription is converted into machine control data or control signals, where a zero surface level defines the position of the blade (e.g., in meters above mean sea level). The end result of the above land smoothing or land leveling does not yield a resultant plane, but rather a surface with shaved off ridges and filled depression cells that improves crop performance in a more economical manner than necessarily achieving a completely planar surface.

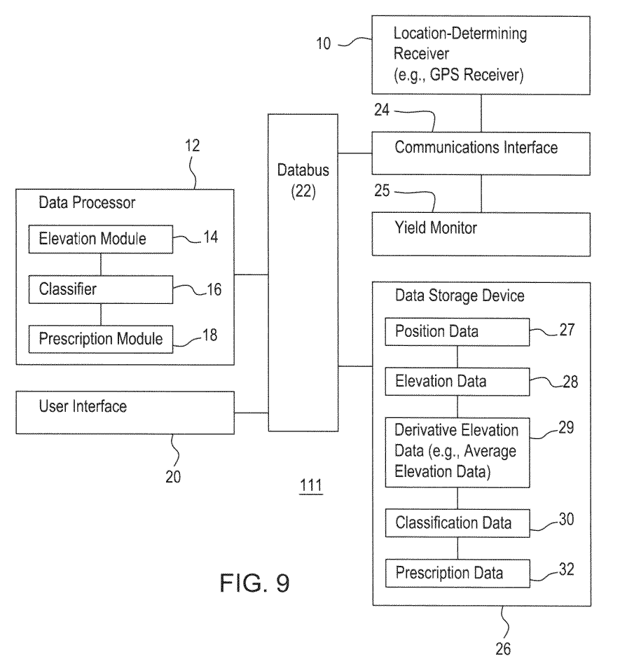

The system 111 of FIG. 9 is similar to the system 11 of FIG. 1, except the system 111 of FIG. 9 further comprises a yield monitor 25 coupled to the communications interface 24 or directly to the data bus 22. The yield monitor 25 comprises a grain flow sensor, a microwave sensor, a radiometric volume sensor, an optical or photo-sensor, or a shaft torque sensor. For example, a grain flow sensor may comprise a potentiometer or a piezoelectric transducer that is mechanically coupled to an impact plate that is struck by harvested grain in a combine or harvester. The piezoelectric transducer changes its resistance or another electrical property in response to compression or the application of force to it. In one embodiment, if the yield monitor 25 provides an analog output signal, it may be digitized or processed by an analog-to-digital converter interposed between the yield monitor 25 and the communications interface 24.

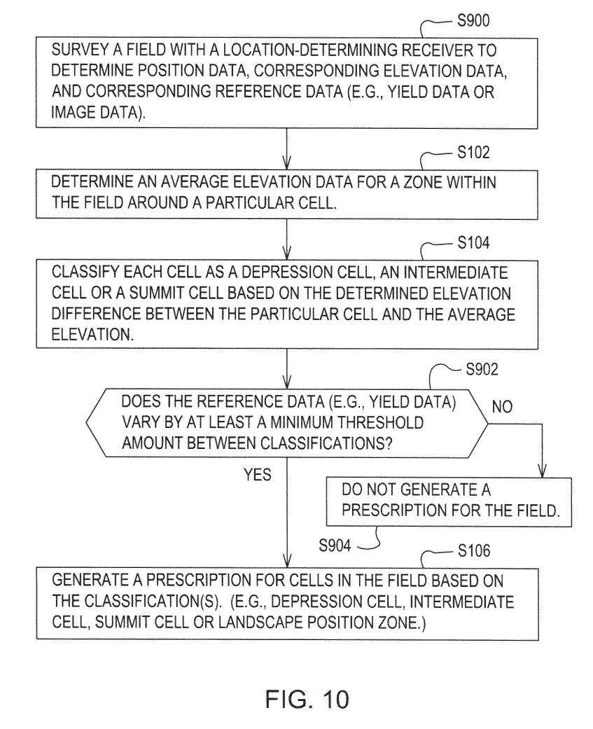

The method of FIG. 10 is similar to the method of FIG. 2, except step 900 of FIG. 9 replaces step S100 of FIG. 2; and steps S902 and S904 are added. Like reference numbers in FIG. 2 and FIG. 10 indicate like procedures or steps.

In step S900, a location-determining receiver 10 and yield monitor 25 or imaging device may be used to survey a field to determine position data 27, corresponding elevation data 28, and corresponding reference data (e.g., yield data, image data, or derivative data derived from the image data) for a particular crop. The reference data may comprise one or more of the following: yield data, average yield data per classification, median yield data per classification, mode yield data per classification image data, average image data per classification, median image data per classification, and mode image data per classification.

In one example for carrying out step S900, the location-determining receiver 10 may obtain position data (e.g., x, y coordinates of a Cartesian coordinate system 11) and elevation data 28 (z coordinate of a Cartesian coordinate system 11) during normal field operations (e.g., during planting, harvesting or spraying), or from a dedicated survey (e.g., transects or grid sampling movements made with a vehicle to collect respective position data 27 and elevation data 28). During, prior or after collection of the elevation data 28, the yield monitor 25 may collect yield data for the crop at respective positions or position data within a field.

In an alternate example for carrying out step S900, an imaging unit (e.g., camera or charged coupled device) may collect image data, aerial image data or satellite image data, which may be processed to yield derivative data such as Normalized Difference Vegetation Index (NDVI), Green Normalized Difference Vegetation Index (GNDVI), or another vegetation index. NDVI is determined based on the reflectance measurements in the humanly visible light band and the infra-red or near infra red band. NDVI may provide an indicator of the relative greenness of leaves or other plant material, for example. GNDVI is similar to NDVI by uses the reflectance measurements predominately in the green wavelength, frequency or band of visible light. The derivative data may be represent the relative differences in biomass versus position in a field, and may be expressed as a single dimensional matrix, a multidimensional matrix or a database.

In step S102, an elevation module 14 or data processor 12 determines average elevation data 28 or derivative elevation data 29 for a defined zone within the field around a particular cell. The cell may be generally rectangular, polygonal or have another geometric shape with a generally uniform surface area. The defined zone may comprise a region within a defined radius, polygon, area or group of adjacent cells.

In step S104, the classifier 16 or data processor 12 classifies each cell as a depression cell, an intermediate cell, a summit cell or with another zone identifier based on the determined elevation difference between the particular cell and the average elevation or derivative elevation data 29. Each zone identifier may represent a distinct range of determined elevation differences between the particular cells and the respective average elevations.

In step S902, a data processor 12 determines whether the reference data (e.g., yield data or image data) varies by at least a minimum threshold amount between different classifications or between different landscape position zones. In one example, the data processor 12 determines zone reference data (e.g., zone yield data or zone image data) that comprises an average, median, mean, or mode yield data for a corresponding classification or landscape position zone. If the reference data (e.g., zone reference data, zone yield data or zone image data) varies by at least a minimum threshold amount (e.g., greater than approximately 5 percent or greater), the method continues with step S106. However, if the reference data (e.g., zone reference data, yield data or image data) does not vary by at least a minimum threshold amount, then the method continues with step S904.

In step S106, the data processor 12 or prescription module 18 generates a prescription based on the classifications (e.g., depression cell, intermediate cell, summit cell, or landscape position zone). The various examples of carrying out step S106 that were described in conjunction with FIG. 2, apply equally here to the method of FIG. 10, as if fully set forth herein.

Further, in step S106 in conjunction with the method of FIG. 10, the data processor 12 or the prescription module 18 may limit or restrict the scope of the prescription to those preferential zones (e.g., landscape position zones) or classifications (e.g., depression cell, intermediate cell, or summit cells) where the reference data varies by at least a minimum threshold between classifications. That is, the data processor 12 or prescription module 18 optionally does not generate a prescription for the remaining zones or classifications, where the reference data does not vary by at least a minimum threshold between classifications. Accordingly, the data processor 12 or prescription module 18 conserves data processing resources and reduces electrical power consumption. In one example, reduced data processing resources may allow the use of less expensive data processors in the data processor 12 or the prescription module 18 with lower data throughput capacity or processing rates (e.g., processed bytes per unit time or completed logical, mathematical or other operations per unit time). In another example, the operator, user or grower may use less resources, crop inputs, time and fuel where the scope of the prescription is limited to the preferential zones or classifications, as indicated above.

In step S904, the data processor 12 or prescription module 18 does not generate a prescription based solely on the classification.

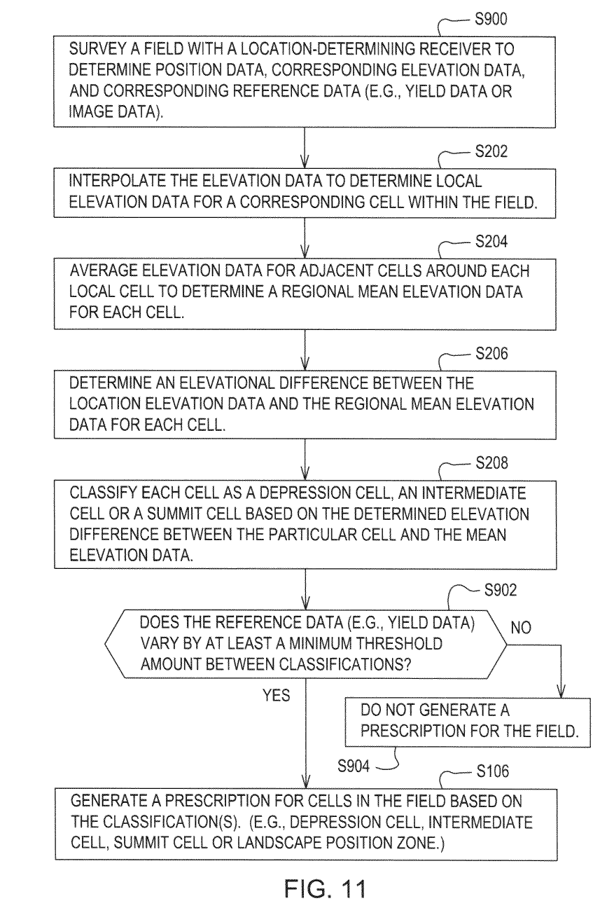

The method of FIG. 11 is similar to the method of FIG. 3, except step 900 of FIG. 11 replaces step S100 of FIG. 3; and steps S902 and S904 are added. Like reference numbers in FIG. 3 and FIG. 11 indicate like procedures or steps.

In step S900, a location-determining receiver 10 and yield monitor 25 may be used to survey a field to determine position data 27, corresponding elevation data 28, and corresponding yield data for a particular crop. The reference data may comprise one or more of the following: yield data, average yield data per classification, median yield data per classification, mode yield data per classification image data, average image data per classification, median image data per classification, and mode image data per classification.

In one example for carrying out step S900, the location-determining receiver 10 may obtain position data (e.g., x, y coordinates of a Cartesian coordinate system 11) and elevation data 28 (z coordinate of a Cartesian coordinate system 11) during normal field operations (e.g., during planting, harvesting or spraying), or from a dedicated survey (e.g., transects or grid sampling movements made with a vehicle to collect respective position data 27 and elevation data 28). Simultaneously, the yield monitor 25 may collect yield data for the crop at respective positions or position data within a field.

In step S202, an elevation module 14 or data processor 12 interpolates the elevation data 28 to determine local elevation data 28 for a corresponding cell within the field. The cell may generally rectangular, polygonal or have another geometric shape of a generally uniform surface area. For example, the elevation module 14 or data processor 12 creates an elevation surface or first data layer based on one or more of the following: (1) the determined position data 27 and corresponding elevation data 28, or (2) interpolated elevation data with associated corresponding position data. Interpolated elevation data means elevation points that represent an average, mean, or mode value or other estimated value of elevation data 28 based on the elevation data 28 associated with the nearest position data or adjacent position data. If the elevation data 28 is expressed as color data in color space (e.g., RGB (red, green, blue) color space or HSV (hue, saturation, value) color space), the processing of the processor 12 or elevation module 14 may take place on the underlying numerical values of elevation (e.g., expressed in feet or meters) or the virtual representation of pixel values or voxel values in color space.

In step S204, an elevation module 14 or data processor 12 averages adjacent cells around each local cell to determine a regional mean elevation data or derivative elevation data 29 or derivative elevation data 29 for each cell. For example, the elevation module 14 or data processor 12 averages adjacent elevation data 28 around each cell (e.g., by a predetermined radius, maximum distance or a defined zone or two-dimensional area) to determine a mean elevation surface for each cell. The aggregate of the mean elevation surfaces for all cells within a region or field may be referred to as a mean filter surface or second data layer.

In step S206, an elevation module 14 or data processor 12 determines an elevation difference between the location elevation data 28 and the regional mean elevation data 28 (or derivative elevation data 29) for each cell. For instance, in step S206 the mean filter surface (e.g., second data layer) is subtracted from the elevation surface (e.g., first data layer) to derive or estimate a landscape position (LSP) surface (e.g., third data layer).

Step S206 may be carried out in accordance with various techniques that may be applied individually or cumulatively. In accordance with a first embodiment, the mean filter surface and elevation surface are expressed as multidimensional matrices or database records with values of elevation data 28 (e.g., z coordinate value) and position data (e.g., x, y coordinate values). Further, the subtraction may take place in accordance standard mathematical techniques. In accordance with a second embodiment, the elevation data 28 is expressed as color data in color space (e.g., RGB (red, green, blue) color space or HSV (hue, saturation, value) color space), the subtraction may take place on the pixel values or voxel values in color space that represent underlying elevation data 28.

In step S208, a classifier 16 or data processor 12 classifies each cell as a depression cell, an intermediate cell, a summit cell or another classification (e.g., distinct zone identifiers associated with different landscape position zones) based on the determined elevation difference between the particular cell and the mean data. Step S208 may be carried out in accordance with various techniques that may be applied alternately or cumulatively. In accordance with a first technique, each distinct zone may contain cells with the same or similar classifications. In accordance with a second technique, each distinct zone is associated with similar ranges of elevation differences with respect to the regional mean elevation. For example, a first zone identifier may describe a first range of elevation differences, whereas a second zone identifier describes a second range of elevation differences distinct (e.g., greater or lower) from the first range. In accordance with a third technique, the LSP surface may be classified (e.g., divided into N zones (1 to N) using various methods such as an equal surface area for each zone). In accordance with a fourth technique, the boundaries (e.g., contour or perimeter coordinates) of each zone may be applied to collected reference data, yield data, or image data to facilitate determination of a mean, median, average, mode of the reference data, yield data, or image data per corresponding zone in step S902 or prior thereto.

In step S902, a data processor 12 determines whether the reference data (e.g., yield data or image data) varies by at least a minimum threshold amount between different classifications or between different landscape position zones. In one example, the data processor 12 determines zone reference data (e.g., zone yield data or zone image data) that comprises an average, mean, or mode yield data for a corresponding classification or landscape position zone. If the reference data (e.g., zone reference data, zone yield data or zone image data) varies by at least a minimum threshold amount (e.g., greater than approximately 5 percent or greater), the method continues with step S106. However, if the reference data (e.g., zone reference data, yield data or image data) does not vary by at least a minimum threshold amount, then the method continues with step S904.

In step S106, the data processor 12 or prescription module 18 generates a prescription based on the classification. The various examples of carrying out step S106 that were described in conjunction with FIG. 2, apply equally here to the method of FIG. 10, as if fully set forth herein.

Further, in step S106 in conjunction with the method of FIG. 10, the data processor 12 or the prescription module 18 may limit or restrict the scope of the prescription to those preferential zones (e.g., landscape position zones) or classifications (e.g., depression cell, intermediate cell, or summit cells) where the reference data varies by at least a minimum threshold between classifications. That is, the data processor 12 or prescription module 18 optionally does not generate a prescription for the remaining zones or classifications, where the reference data does not vary by at least a minimum threshold between classifications. Accordingly, the data processor 12 or prescription module 18 conserves data processing resources and reduces electrical power consumption. In one example, reduced data processing resources may allow the use of less expensive data processors in the data processor 12 or the prescription module 18 with lower data throughput capacity or processing rates (e.g., processed bytes per unit time or completed logical, mathematical or other operations per unit time). In another example, the operator, user or grower may use less resources, crop inputs, time and fuel where the scope of the prescription is limited to the preferential zones or classifications, as indicated above.

In step S904, the data processor 12 or prescription module 18 does not generate a prescription based solely on the classification.

The method for making a land management decision is well suited for modifying various crop input decisions, improving water movement patterns, and improving crop yields and water utilization. The above method can be implemented in a highly automated procedure that consistently creates an LSP layer, or derivatives thereof for land management tasks. For example, the LSP layer can be converted to agronomically useful prescriptions for various inputs or field reports (e.g., percentage of each LSP zone in each field). It should be recognized that the above method offers a considerable advantage for agronomic decisions because LSP zones provide a more definitive description of the plant growth environment (e.g., depression, slope, summit cells), independent of the range of elevation observed in each field. For example, a poorly drained area offers an adverse environment for most plants whether at the bottom of a 30 meter slope or 30 cm slope.

Having described the preferred embodiment, it will become apparent that various modifications can be made without departing from the scope of the invention as defined in the accompanying claims.

The following are claimed:

1. A method for making a land management decision, the method comprising:
surveying a field with a location-determining receiver to determine position data and corresponding elevation data;
determining an average elevation data for a defined zone within the field around a particular cell;
classifying each cell into classifications comprising a depression cell and a summit cell based on the determined elevation difference between the particular cell and the average elevation data; and
generating a prescription for the cells in the field based on at least one of the classification or the determined elevation difference, the prescription comprising information on applying different levels of an agricultural input to particular cells based on at least one of the classifications of particular ones of the cells or the determined elevation differences for particular ones of the cells.

2. The method according to claim 1 where the prescription comprises a first agricultural input amount of the agricultural input for the summit cell that differs from a second agricultural input amount for the depression cell.

3. The method according to claim 1 wherein the generating of the prescription comprises allocating a greater amount of water to summit cells than depression cells, where the water comprises the agricultural input.

4. The method according to claim 1 wherein generating of the prescription comprises allocating a greater amount of nitrogen fertilizer to the summit cells and a lesser amount of nitrogen fertilizer to the depression cells, where the nitrogen fertilizer comprises the agricultural input.

5. The method according to claim 1 wherein generating of the prescription comprises generating a plan to vary seeding rates of seed based the classifications, where the seed comprises the agricultural input.

6. The method according to claim 1 wherein the generating of the prescription further comprises generating a plan to increase the tillage depth in depression cells and to reduce or use a low tillage procedure for summit cells.

7. The method according to claim 1 wherein the generating of the prescription comprises establishing a plan to use genetically tailored or drought-resistant seeds for the summit cells, where the seed comprises the agricultural input.

8. The method according to claim 1 wherein the generating of the prescription comprises establishing a plan to use seeds treated with mildewicide or water-resistant seed varieties in depression cells, where the seeds comprise the agricultural input.

9. The method according to claim 1 wherein the classifications further comprise intermediate cells with elevation differences intermediate to those of the depression cells and summit cells; and wherein summit cells and intermediate cells are associated with less available moisture in their top soil than depression cells.

10. The method according to claim 1 wherein the classifications further comprise intermediate cells with elevation differences intermediate to those of the depression cells and summit cells; and wherein the summit cells and intermediate cells are associated with lesser water holding capacity than the depression cells.

11. A method for making a land management decision, the method comprising:
surveying a field with a location-determining receiver to determine position data and corresponding elevation data;
averaging adjacent cells around each local cell to determine a regional mean elevation data for each cell;
determining an elevation difference between the location elevation data and the regional mean elevation data for each cell;
classifying each cell into classifications comprising at least a depression cell and a summit cell based on the determined elevation difference; and
applying different levels of crop inputs to cells in the field based on the different classifications.

12. The method according to claim 11 where the prescription comprises a first agricultural input amount of the agricultural input for the summit cell that differs from a second agricultural input amount for the depression cell.

13. The method according to claim 11 wherein the generating of the prescription comprises allocating a greater amount of water to summit cells than depression cells, where the water comprises the agricultural input.

14. The method according to claim 11 wherein generating of the prescription comprises allocating a greater amount of nitrogen fertilizer to the summit cells and a lesser amount of nitrogen fertilizer to the depression cells, where the nitrogen fertilizer comprises the agricultural input.

15. The method according to claim 11 wherein generating of the prescription comprises generating a plan to vary seeding rates of seed based the classifications, where the seed comprises the agricultural input.

16. The method according to claim 11 wherein the generating of the prescription further comprises generating a plan to increase the tillage depth in depression cells and to reduce or use a low tillage procedure for summit cells.

17. The method according to claim 11 wherein the generating of the prescription comprises establishing a plan to use genetically tailored or drought-resistant seeds for the summit cells, where the seed comprises the agricultural input.

18. The method according to claim 11 wherein the generating of the prescription comprises establishing a plan to use seeds treated with mildewicide or water-resistant seed varieties in depression cells, where the seeds comprise the agricultural input.

19. The method according to claim 11 wherein the classifications further comprise intermediate cells with elevation differences intermediate to those of the depression cells and summit cells; and wherein summit cells and intermediate cells are associated with less available moisture in their top soil than depression cells.

20. The method according to claim 11 wherein the classifications further comprise intermediate cells with elevation differences intermediate to those of the depression cells and summit cells; and wherein the summit cells and intermediate cells are associated with lesser water holding capacity than the depression cells.

21. The method according to claim 11 further comprising:
interpolating the elevation data to determine local elevation data for a corresponding cell within the field.

22. A method for making a land management decision, the method comprising:
surveying a field with a location-determining receiver to determine position data and corresponding elevation data;
determining an average elevation data for a defined zone within the field around a particular cell;
classifying each cell as a depression cell, an intermediate cell and a summit cell based on the determined elevation difference between the particular cell and the average elevation; and
generating a prescription for the cells in the field based on at least one of the classification or the determined elevation difference, the prescription comprising information on changing an elevation of one or more cells to achieve a target elevation.

23. The method according to claim 22 further comprising:
removing soil from summit cells to fill in depression cells to meet the determined average elevation for a group of the cells.

24. The method according to claim 22 wherein the generating further comprises generating a desired height for each cell based on the determined elevation difference between an actual cell height and the average cell height.

25. The method according to claim 22 wherein the generating further comprises generating the prescription comprising instructions for or information on adding soil or material to depression cells.

26. A method for making a land management decision, the method comprising:
surveying a field with a location-determining receiver to determine position data, corresponding elevation data and corresponding reference data;
determining an average elevation data for a defined zone within the field around a particular cell;
classifying each cell into classifications comprising a depression cell and a summit cell based on the determined elevation difference between the particular cell and the average elevation data;
determining a correlation value between the elevation data and the yield data for respective position data;
generating a prescription for the cells in the field based on at least one of the classification or the determined elevation difference if the reference data varies by at least a minimum threshold amount between classifications, a scope of the prescription limited to preferential cells where the reference data varies by at least the minimum threshold amount.

27. The method according to claim 26 wherein the reference data comprises at least one of yield data, average yield data per classification, median yield data per classification, and mode yield data per classification.

28. The method according to claim 26 wherein the reference data comprises at least one of image data, average image data per classification, median image data per classification, and mode image data per classification.
